(19) United States
(12) Patent Application Publication
(10) Pub. No.: US 2007/0209162 A1
(43) Pub. Date: Sep. 13, 2007

(54) Auxiliary handle for reciprocating saw

(76) Inventors: Jason McRoberts, Red Lion, PA (US); Terry L. Turner, Towson, MD (US); Jason Busschaert, Towson, MD (US); Ruth Mitchener, Baltimore, MD (US); Vincent P. Cooper, Baltimore, MD (US)

Correspondence Address: HARNESS, DICKEY & PIERCE, P.L.C., P.O. BOX 828, BLOOMFIELD HILLS, MI, 48303, US

(21) Appl. No.: 11/372,456

(22) Filed: Mar. 9, 2006

(51) Int. Cl. B25G 1/00

(52) U.S. Cl. 16/426

(57) ABSTRACT

A power tool has an auxiliary handle with a handle member and a securement member. The handle member is unitarily formed with the securement member. The securement member forms a loop to secure the auxiliary handle to the power tool. A positioning tab is on an interior surface of the securement member. The positioning tab is adapted to cooperate with a tab recess on the power tool housing to position the auxiliary handle in one of a plurality of positions on the power tool. A latch mechanism tightens the loop to engage the positioning tab in the tab receiving member to lock the auxiliary handle onto the power tool.

### FIELD

The present disclosure relates to power tools and, more particularly, to an auxiliary handle for a reciprocating saw.

### BACKGROUND

The statements in this section merely provide background information related to the present disclosure and may not constitute prior art.

The majority of hand held power tools include a main handle to manipulate the power tool. Drills (rotary, percussive, rotary percussive), saws (reciprocating, saber, chain), sanders (vibratory, orbital, band) or the like power tools provide such a handle for the operator. The main handle enables the user to manipulate the power tool during use. However, sometimes, the user would prefer to have an additional handle for the power tool. The auxiliary handle provides the user with an alternative control means, which enables the user to apply more force, and to relieve stress or the like during use of the power tool. Some power tools include auxiliary handles built into the tool. However, sometimes it is desirable to use the tool with just its main handle since the auxiliary handle may be an obstruction. Thus, it is desirous to have an auxiliary handle which can be removably attached to the power tool.

The present teachings provide an auxiliary handle which is readily removable from the power tool. The auxiliary handle is multi-positional on the power tool to provide multiple handling positions, and includes a locking mechanism to prevent it from slipping or moving during use.

### SUMMARY

According to the teachings, an auxiliary handle for a power tool comprises a handle and a securement member. The handle is unitarily formed with the securement member. The securement member forms a loop to secure the auxiliary handle to the power tool. A lock positioning tab is on an interior surface of the securement member. The lock positioning tab is adapted to cooperate with a lock tab recess on the power tool to position the auxiliary handle in one of a plurality of positions on the power tool. A latch tightens the securement member loop to engage the lock positioning tab and the lock tab recess to lock the auxiliary handle with the power tool. The securement member generally includes a first element with two ends unitarily formed with the handle. A second element, with two ends, has one end pivotally coupled with an end of the first element. The other end of the first and second elements is associated with the latch. One element includes a hook and the other the latch. An over center latch has a clasp, which couples with the hook, and a lever to move the clasp between positions. The securement member loop defines a central axis. The handle and securement member are in a plane transverse to the central axis. The lock positioning tab is on one or both of the first and second elements. The lock positioning tab projects from the interior surface and has a desired configuration to mate in a recess of the lock tab recess. The handle has an overall U-shape with the legs and web uniformly formed with the securement member to provide an aperture for a user's hand. Ordinarily the web includes a textured tactile surface or grip to enhance the feel of the handle.

Further, according to the teachings, a power tool is comprised of a housing which includes a lock tab receiving member on its exterior surface. A motor is positioned within the housing. An output is coupled with the motor to drive a tool. A power source is electrically coupled with the motor. An actuation member is coupled with the motor and the power source. The actuation member activates and deactivates the motor to drive the output. An auxiliary handle is removably coupled with the housing.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a power tool in accordance with the present invention.

FIG. 2 is an exploded view of the handle with a portion of the power tool housing.

FIG. 3 is an exploded view like that of FIG. 2 of an additional embodiment of the present invention.

### DETAILED DESCRIPTION

The following description is merely exemplary in nature and is not intended to limit the present disclosure, application, or uses.

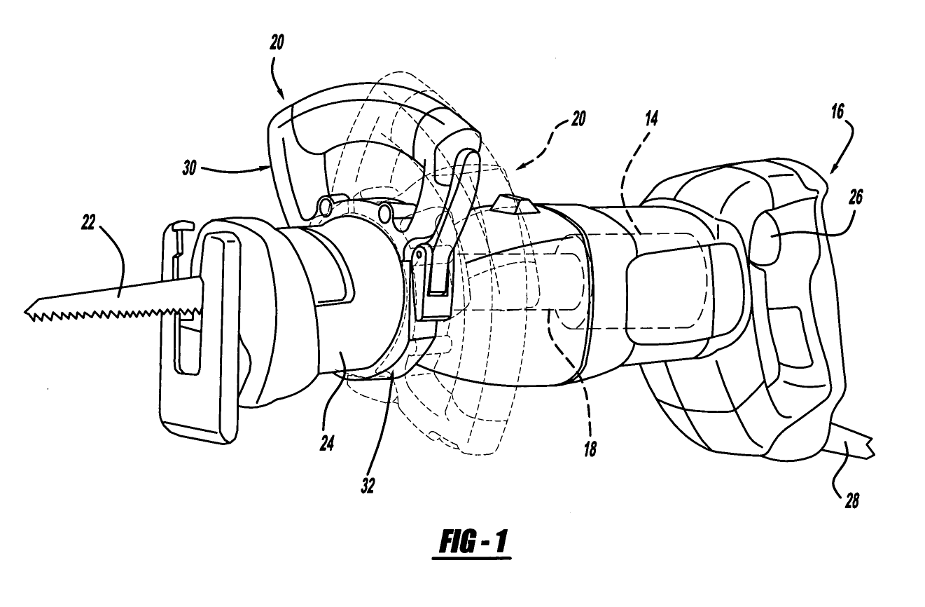

Turning to the figures, particularly FIG. 1, a power tool 10 is illustrated with an auxiliary handle 20 of the present invention. The illustrated power tool is a reciprocating saw including a housing 12, motor 14, main handle 16, output 18, cutting tool 22, activating member 26 and power cord 28.

The auxiliary handle 20 is shown secured to the front output cover 24. The auxiliary handle 20 is multi-positional about the front output cover 24, with its various positions shown in phantom. The coupling mechanism will be discussed in detail below.

The auxiliary handle 20 includes a handle member 30 and a securement member 32. The securement member 32 comprises first element 38 and second element 56. The handle member 30 has an overall U-shape with legs 34 and 36 unitarily formed with the first element 38 of the securement member 32. A web 40 of the handle member 30 spans between the legs 34 and 36. The web 40 includes a grip 42 which provides texture to the handle member 30. The grip 42 may be made from an elastomeric or rubber member having various designs to provide texture and a tactile feel to the handle member 30. Also, the grip 42 may include indicia 44. Further, the grip 42 is ordinarily overmolded onto the web 40 of the handle member 30. An aperture 46 is formed between the U-shaped handle member 30 and the first element 38 of the securement member 32. The aperture 46 enables the user's hand to be received so that it may surround the web 40 of the handle member 30.

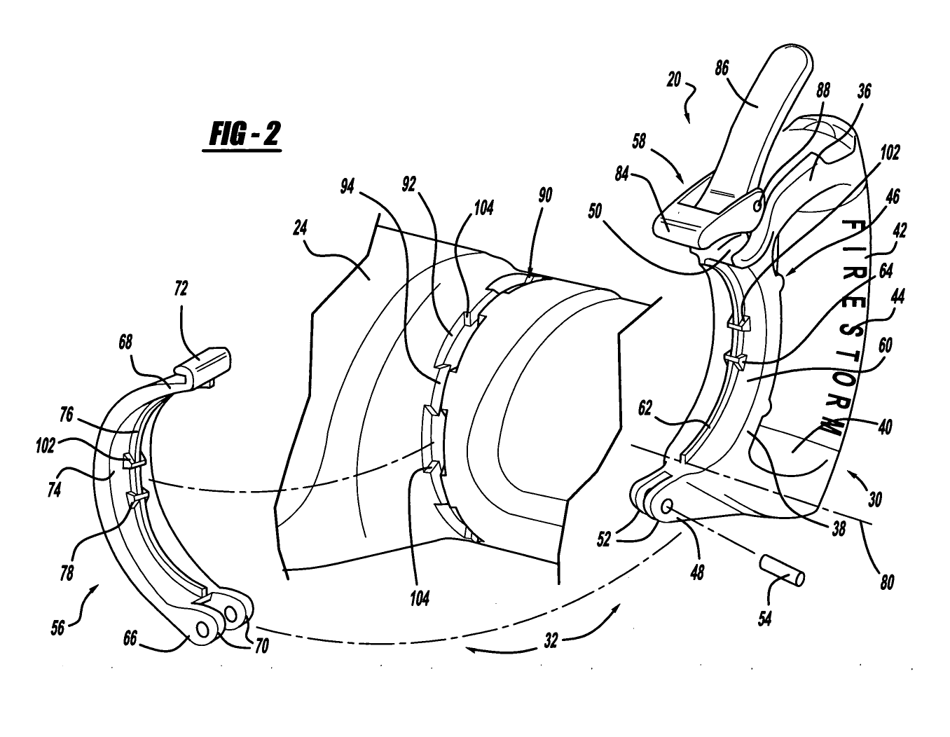

The first element 38 has an overall arcuate shape with two ends 48 and 50. The end 48 includes stirrups 52 which receive a pin 54 to pivotally couple the second element 56 of the securement member 32 with the first element 38. The other end 50 includes a latch 58. The first element 38 includes an interior surface 60 following an arcuate, substantially circular path. The interior surface 60 includes a circumferential rib 62 which projects from the interior surface 60. The rib 62 is positioned within the front output cover 24, as will be explained later. Also, one or more lock positioning tabs 64 project from the interior surface 60. The lock positioning tabs 64 couple with the front output cover 24. The tabs 64 have an overall triangular shape to enable proper position of the handle member 30 with respect to the output cover 24. Ordinarily, two pairs of tabs 64 are juxtaposed with respect to one another. Also, a portion of the ribs 62 separate the two pairs of tabs 64, as best seen in FIG. 2.

The second element 56 also has an overall arcuate shape. The second element 56 includes two ends 66 and 68. The end 66 includes a pair of stirrups 70 which receive the pin 54 to couple with the first element 38. The second end 68 includes a hook 72 which couples with the latch 58. The second element 56 includes an interior surface 74 which includes a projecting circumferential rib 76 and one or more lock positioning tabs 78. The tabs 78, as well as the rib 76, are substantially similar to those on the first element 38.

The securement element 32 provides a loop which defines a central axis 80. The securement member 32 as well as the handle member 30 is in a plane transverse to the central axis 80. In fact, the handle member 30 and securement member 32 are substantially co-planar. As shown, the handle member 30 is unitarily formed with the first element 38 of the securement member 32. The second element 56 is pivoted with respect to the first element 38. However, it is possible to have the securement member 32 as a one piece member eliminating the pivot and still providing the loop as shown. Also, the entire auxiliary handle could be a one piece unitary device.

The latch 58 includes a clasp 84 and lever 86. The lever 86 is pivotally secured to the end 50 of the first element 38. The clasp 84 of the latch 58 is pivotally secured with the lever 86 by pin 88. The latch 58 is an over center type so that the clasp 84 is secured to the hook 72. The lever 86 is manipulated to move towards the handle member 30. As this occurs, the tabs 64, 78 of the first element 38 and second element 56 engage the cover 24. As the lever 86 is moved away from the handle member 30, the clasp 84 releases the hook 72, opening the auxiliary handle. This enables the auxiliary handle 20 to be removed from the power tool.

The front output cover 24 includes a lock tab receiving member 90. The lock tab receiving member 90 includes a plurality of substantially rectangular tab recesses 92 connected with one another by a groove 94. The groove 94 receives the ribs 62 and 76 of the securement member 32. The tabs 64 and 78 are received in the recesses 92. The plurality of recesses 92 enable the auxiliary handle 20 to be positioned in a plurality of different positions about the front output cover 24 as seen in FIG. 1. Thus, the recesses 92 lock the tabs 64 and 78 to position the auxiliary handle 20 onto the front output cover 24.

The auxiliary handle 20 is positioned on the front output cover 24. When the lever 86 is pivoted away from the handle 30, the second element 56 is free to be pivoted away from the first element 38. The first element tabs 64 can then be positioned into a desired recess 92. The second element 56 can then be pivoted to close the securement member loop 32. This, in turn, engages tabs 78 into a recess 92. The latch clasp 84 is coupled with the hook 72 and the lever 86 is pushed toward the handle member 30. This locks the auxiliary handle 20 onto the front output cover 24. To remove or adjust the auxiliary handle 20, the lever 86 is moved away from the handle member 30 to enable the hook 72 to be removed from the latch clasp 84 which, in turn, enables removal of the auxiliary handle 20. To adjust the position of the auxiliary handle 20 with respect to the front output cover 24, the latch 58 is in a released condition with the latch clasp 84 still connected to the hook 72. This enables the auxiliary handle 20 to be rotated about the front output cover 24 from position to position without removing the auxiliary handle 20 from the front output cover 24. The tabs 64, 78 have ramped surfaces 102 which mate with the recess ramp surfaces 104 which enable the tabs 64, 78 to move out of the recesses 92.

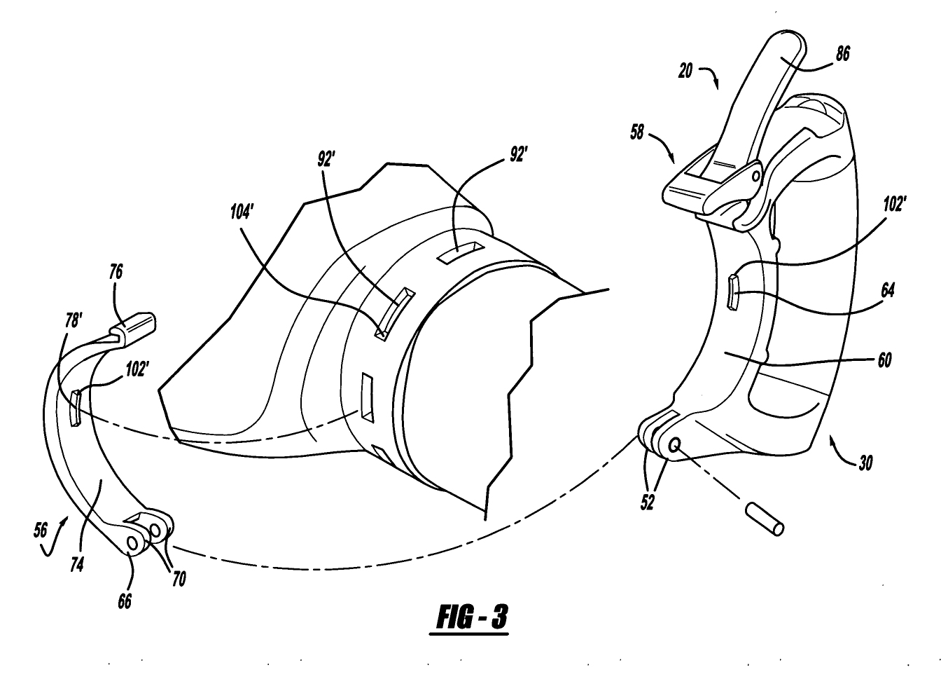

FIG. 3 is an alternate embodiment of the present invention. The elements which are the same as those previously discussed are marked with the same reference numerals. The difference between this embodiment and the previous embodiment is the lock tabs which position the auxiliary handle 20 onto the front output cover 24.

The recesses 92′ are not connected to one another via a groove. The first element 38 and the second element 56 include a single lock positioning tab 64′ and 78′, which is received in the recesses 92′. The recesses 92′, as well as the tabs 64′ and 78′, include ramp surfaces 102′, 104′ to enable the auxiliary handle to be moved from position to position. The ramps 102′, 104′ enable the lock tabs 64′ and 78′ to exit the recesses 92′ and move along the outer surface of the front output cover 24 to the next discrete recess 92′.

The description of the invention is merely exemplary in nature and, thus, variations that do not depart from the gist of the invention are intended to be within the scope of the invention. Such variations are not to be regarded as a departure from the spirit and scope of the disclosure.

What is claimed is:

1. An auxiliary handle for a power tool comprising:
a handle member and a securement member, said handle member formed with said securement member;
said securement member forming a loop for securing the auxiliary handle to the power tool;
a positioning tab on an interior surface of said securement member, said positioning tab adapted to cooperate with a tab recess on the power tool for positioning said auxiliary handle in one of a plurality of positions on the power tool; and
a latch for tightening said loop for engaging said positioning tab in the tab receiving member for locking the auxiliary handle onto the power tool.

2. The auxiliary handle according to claim 1, wherein said securement member includes a first element with two ends formed with said handle member, and a second element with two ends having one end pivotally coupled to an end of said first element and the other ends of said first and second elements releasably lockable with one another.

3. The auxiliary handle according to claim 2, wherein the positioning tab is on each said first and second elements.

4. The auxiliary handle according to claim 1, wherein said loop defines a central axis, said handle member and said securement member being in a plane transverse to said central axis.

5. The auxiliary handle according to claim 1, wherein said positioning tab projects from said interior surface having ramped surfaces to mate in a recess of the tab recess.

6. The auxiliary handle according to claim 1, wherein said handle member has an overall U-shape, with legs of said U-shaped handle unitarily formed with said securement member to provide an aperture for a user's hand.

7. The auxiliary handle according to claim 6, wherein a web of the U-shaped handle has an overmold providing a textured surface.

8. The auxiliary handle according to claim 1, wherein said latch includes a clasp and a lever, the clasp located on one of the first or second element of the securement member, the clasp coupling with a hook on the other of the first or second element, the clasp being movable between a first and second position to lock and unlock the auxiliary handle onto the power tool.

9. A power tool comprising:
a housing, said housing including a tab recess on its exterior surface;
a motor in said housing;
an output coupled with said motor for driving a tool;
a power source electrically coupled with said motor;
an actuation member coupled with said motor and said power source for activating and deactivating said motor for driving said output; and
an auxiliary handle removably coupled with said housing, said auxiliary handle comprising:
a handle member and a securement member, said handle member formed with said securement member;
said securement member forming a loop for securing the auxiliary handle to the power tool;
a positioning tab on an interior surface of said securement member, said positioning tab adapted to cooperate with said tab recess on the housing for positioning said auxiliary handle in one of a plurality of positions on the power tool; and
a latch for tightening said loop and thereby engaging said positioning tab in the tab recess for locking the auxiliary handle on the power tool.

10. The power tool according to claim 9, wherein said securement member includes a first element with two ends formed with said handle member, and a second element with two ends having one end pivotally coupled to an end of said first element and the other ends of said first and second elements releasably lockable with one another.

11. The power tool according to claim 10, wherein the positioning tab is on each said first and second elements.

12. The power tool according to claim 9, wherein said loop defines a central axis, said handle member and said securement member being in a plane transverse to said central axis.

13. The power tool according to claim 9, wherein said positioning tab projects from said interior surface having ramped surfaces to mate in the tab recess.

14. The power tool according to claim 9, wherein said handle member has an overall U-shape, with legs of said U-shaped handle unitarily formed with said securement member to provide an aperture for a user's hand.

15. The power tool according to claim 14, wherein a web of the U-shaped handle has an overmold providing a textured surface.

16. The power tool according to claim 9, wherein said securement member includes a first element with two ends formed with said handle member, and a second element with two ends having one end pivotally coupled to an end of said first element and the other ends of said first and second elements releasably lockable with one another.
